(19) United States
(12) Patent Application Publication
(10) Pub. No.: US 2026/0158346 A1
(43) Pub. Date: Jun. 11, 2026

(54) SOUND-ABSORBING PICKLEBALL PADDLE SURFACE

(71) Applicant: TTI International, LLC, Dallas, TX (US)

(72) Inventor: Vincent Gallacher, Falmouth, ME (US)

(73) Assignee: TTI International, LLC, Dallas, TX (US)

(21) Appl. No.: 19/369,904

(22) Filed: Oct. 27, 2025

Related U.S. Application Data
(60) Provisional application No. 63/712,749, filed on Oct. 28, 2024.

(51) Int. Cl. A63B 59/42; D04H 1/4326; G10K 11/162

(52) U.S. Cl. CPC A63B 59/42; D04H 1/4326; G10K 11/162; A63B 2209/00; D10B 2321/021; D10B 2507/00

(57) ABSTRACT

A pickleball paddle includes a striking surface and a sound-absorbing cloth disposed on the striking surface. The sound-absorbing cloth includes a fiber blend including at least about 10 weight % para-aramid fibers or at least about 30 weight % high-elongation polyester fibers. The sound-absorbing cloth further includes at least about 1 weight % nylon fibers.

### CROSS-REFERENCE TO RELATED APPLICATIONS

This application claims the benefit of and priority to U.S. Provisional Patent Application No. 63/712,749, filed Oct. 28, 2024, the entire disclosure of which is incorporated by reference herein.

### FIELD

The present disclosure relates generally to the sport of pickleball, and more particularly, to pickleball paddles, and even more particularly, to reducing noise associated with the use of pickleball paddles.

### BACKGROUND

Pickleball is a popular sport that includes elements of tennis, badminton, and table tennis. Pickleball gameplay can be loud, generating sounds of 85 decibels or more. The noise results mostly from pickleball paddles striking balls. To prevent noise nuisance, there is a need for pickleball paddles that are not as loud as current paddle technology.

### SUMMARY OF THE INVENTION

Embodiments disclosed herein address noise issues associated with pickleball play by utilizing, as one example, a specially designed felted cloth material. The material can incorporate single or multiple fiber types and blends, combined with protective coatings, to optimize sound absorption, enhance durability, and maintain the integrity of the pickleball paddle and play via acceptable surface friction, appropriate surface deflection and acceptable coefficient of restitution.

In some embodiments, the techniques described herein relate to a pickleball paddle. The pickleball paddle includes a striking surface and a sound-absorbing cloth disposed on the striking surface. The sound-absorbing cloth includes a fiber blend including at least about 10 weight % para-aramid fibers and at least about 1 weight % nylon fibers.

In some embodiments, the techniques described herein relate to a sound-absorbing cloth. The sound-absorbing cloth includes a fiber blend including at least about 30 weight % high-elongation polyester fibers and at least about 1 weight % nylon fibers.

In some embodiments, the techniques described herein relate to a method of assembling a pickleball paddle. The method includes providing a pickleball paddle including a striking surface. The method further includes providing a sound-absorbing cloth including a fiber blend. The fiber blend includes at least about 10 weight % para-aramid fibers or at least about 30 weight % high-elongation polyester fibers, and at least about 20 weight % nylon fibers. The method further includes fixing the sound-absorbing cloth to the striking surface.

### BRIEF DESCRIPTION OF THE DRAWINGS

FIG. 1 illustrates a pickleball paddle with a sound-absorbing cloth on the paddle striking surface.

FIG. 2 illustrates the sound-absorbing cloth partially peeled off the pickleball paddle.

FIG. 3A illustrates a striking surface of the sound-absorbing cloth.

FIG. 3B illustrates an adhesive surface of the sound-absorbing cloth.

FIG. 4 illustrates a microstructure of non-woven fibers in the sound-absorbing cloth.

FIG. 5 plots acoustic performance curves of various fibers incorporates into the sound-absorbing cloth.

FIG. 6 plots sound generated by various pickleball paddles.

FIG. 7 plots the coefficient of friction for various pickleball coating options.

FIG. 8 plots the static coefficient of friction versus the actual coefficient of friction of a pickleball paddle.

FIG. 9 plots the surface roughness of various sound-absorbing cloths.

FIG. 10 plots the surface deflection of various pickleball paddles.

FIG. 11 is a flowchart of a method of assembling a pickleball paddle.

### DETAILED DESCRIPTION

Applying non-woven (e.g., felted and/or spunbound) cloth material to striking surfaces of pickleball paddles can reduce the noise of pickleball paddles striking objects (e.g., balls, other paddles, and/or other objects). The non-woven cloth material includes a single fiber material or multiple fiber materials. In some embodiments, the non-woven cloth material further includes fiber blends and protective coatings to enhance sound absorption and durability. The non-woven cloth material includes a mixture of para-aramid and nylon fibers to reduce sound output by the pickleball paddle when it strikes an object. In some embodiments, the non-woven cloth material further includes an acrylic polymer coating to further reduce sound output and protect the non-woven fibers. In some embodiments, the cloth material is manufactured onto a striking surface of a pickleball paddle. In other embodiments, the cloth material includes an adhesive backing and is configured to be attached to the striking surface of the pickleball paddle after manufacture (e.g., as a component sold separately from the pickleball paddle). A standard threshold (e.g., quiet standard) for “loud” sound levels compared to “quiet” sound levels is 80 decibels. In some embodiments, applying the non-woven cloth material to the striking surface of the pickleball paddle reduces the sound of balls striking the striking surface from a sound level above 80 decibels to a sound level below 80 decibels (e.g., reducing the sound from about 85 decibels to about 79 decibels). While reference is made to pickleball paddles, the reference is not intended to be limiting. The sound-absorbing cloth material can be disposed on a variety of surfaces, including ping pong paddles, table tennis paddles, padel paddles, or other surfaces.

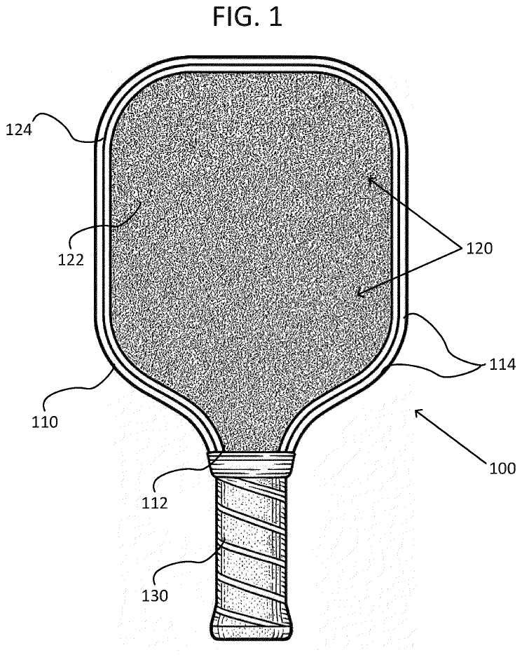

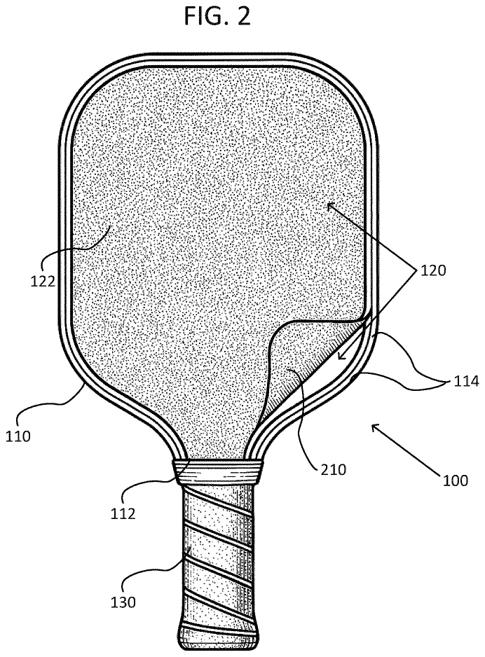

Referring to FIGS. 1-2, a pickleball paddle 100 is illustrated in which a head/striking surface 120 includes or is otherwise formed with a sound-absorbing cloth 122 (e.g., sound-absorbing layer) to reduce noise associated with a pickleball play. As explained in greater detail below, according to some embodiments, the sound-absorbing layers includes a felted cloth material made from multiple fiber types and blends, treated with coatings to enhance durability and performance. In FIGS. 1-2, the pickleball paddle 100 includes a striking body 110 and a handle 130, which connects to a base 112 of the striking body 110. As illustrated, the pickleball paddle 100 includes the striking surface 120 disposed on opposite sides of the striking body 110 (i.e., a front side and an opposed back side of the striking body 110). The sound-absorbing cloth 122 can be formed of a variety of materials and/or combinations thereof, including for example, a cloth material. As illustrated in the embodiment in FIG. 1, the sound-absorbing cloth 122 overlays or otherwise forms a part of all or a portion of the striking surface 120. During use, when a player swings the paddle 100 to hit a ball, the sound-absorbing cloth 122 collides elastically with a ball. In some embodiments, an edge guard 124 may wrap or otherwise extend around a perimeter 114 of the striking body 110. As shown in FIG. 2, the sound-absorbing cloth 122 is configured to be attached to the striking surface 120 by an adhesive backing 210 disposed on at least one side of the sound-absorbing cloth 122. In other embodiments, the sound-absorbing layer is attached to the striking surface by other attachment mechanisms (e.g., glue, nails, screws, the perimeter (rim) 114, or other attachment mechanisms).

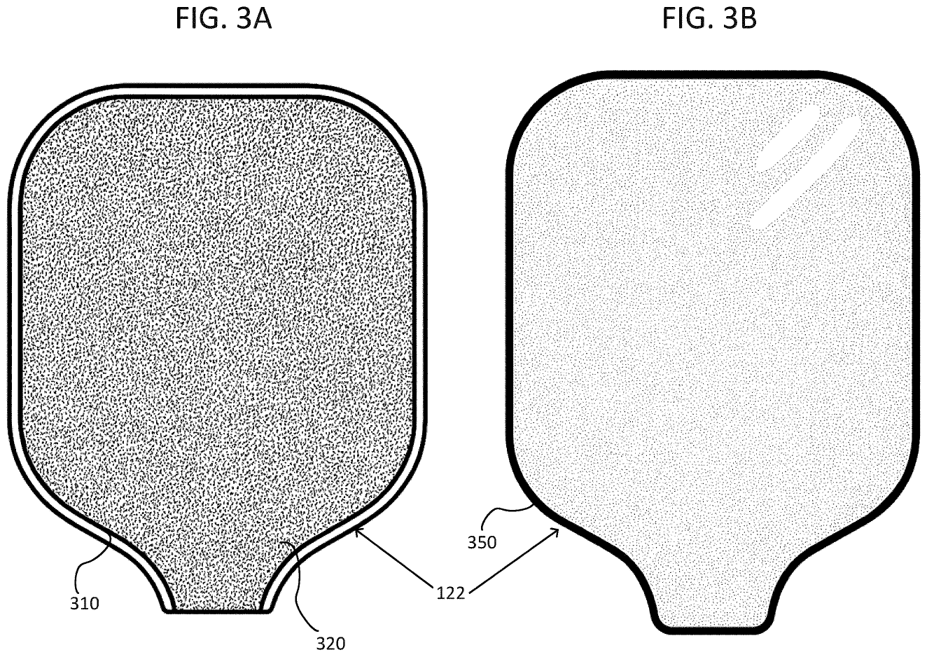

In the embodiment illustrated in FIGS. 3A and 3B, the sound-absorbing cloth 122 includes a felted side 310 and an opposed attachment side 350. According to some embodiments, the felted side 310 includes a non-woven fiber composite 320 and is, as discussed in greater detail below, configured to attach to and cover all or a portion of the striking surface 120, as shown in FIG. 1. In other embodiments, the sound-absorbing cloth 122 is manufactured as the top layer of the striking surface 120. Referring specifically to FIG. 3B, the attachment side 350 includes an adhesive backing including an adhesive, glue, or the like configured to attach to the pickleball paddle 100. In other embodiments, the attachment side 350 may include a hook and loop type fastener or any another temporary or permanent adhesive or non-adhesive means of attachment. In some embodiments, the attachment side 350 includes rubber, acrylate polymer, synthetic thermoplastic elastomer, silicone rubber adhesives, or other adhesives, and can be melted onto the striking surface 120. In other embodiments, the attachment side 350 does not include an adhesive layer. In some embodiments, the attachment side 350 is identical to the felted side 310.

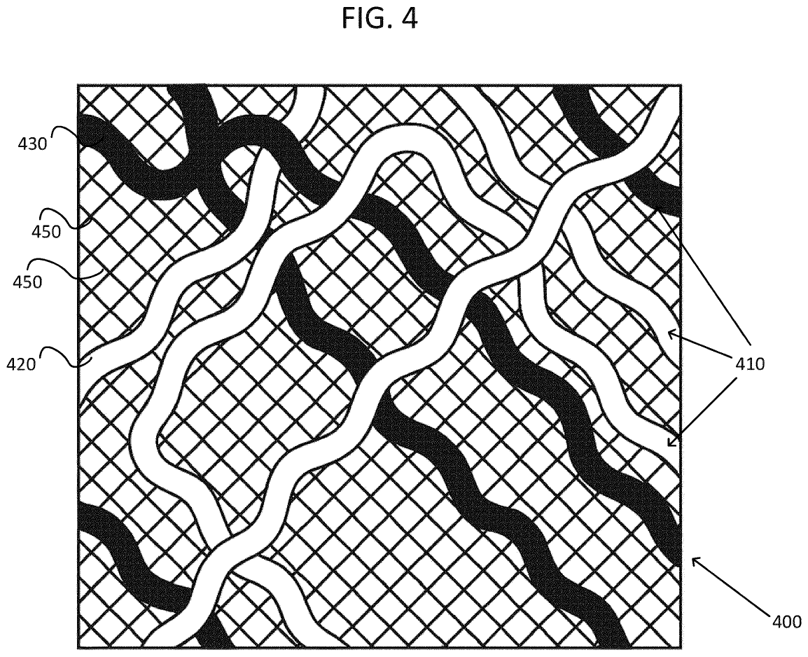

In the embodiment illustrated in FIG. 4, a felt microstructure 400 is illustrated. In some embodiments, the sound-absorbing cloth 122 shown in FIG. 2 includes, in whole or in part, the felt microstructure 400. According to embodiments disclosed herein, the felt microstructure 400 includes a non-woven fiber blend 410. In use, the non-woven fiber blend 410 acts to reduce the noise associated with and otherwise resulting from balls that strike the sound-absorbing cloth 122 disposed on the striking surface 120. In some embodiments, the non-woven fiber blend 410 absorbs sound. The non-woven fiber blend 410 includes fiber 420 and fiber 430, which are examples of individual fibers in the non-woven fiber blend 410. The non-woven fiber blend 410 includes many fibers identical to fibers 420 and 430. In some embodiments, the fibers 420 and 430 are a single continuous synthetic fiber. In other embodiments, the fibers 420 and 430 are separate fibers. In some embodiments, the fibers 420 and 430 have a substantially similar thickness. In other embodiments, the fibers 420 and 430 have different thicknesses. In some embodiments, the fibers 420 and 430 include the same polymer; however, it should be understood that in other embodiments, fiber 420 includes different polymers from fiber 430. In some embodiments, the fibers 420 and 430 have a coating.

In some embodiments, fiber 420 includes a para-aramid polymer. In other embodiments, fiber 420 includes a high-elongation polyester. High-elongation polyester fibers are polyester fibers that elongate at least ten percent of their original length before breaking in a tensile test. In some embodiments, fiber 430 includes nylon. In other embodiments, the fibers 420 and 430 may include acrylics, meta-aramids, polypropylene, polyphenylene sulfide, or other natural or synthetic non-woven fibers. According to embodiments disclosed herein, the felt microstructure 400 may optimize surface friction, surface deflection, and the coefficient of restitution for pickleball.

In some embodiments, the felt microstructure 400 is supported by a textile scrim matrix 450. The textile scrim matrix 450 may add strength and rigidity to the felt microstructure 400. In some embodiments, the textile scrim matrix 450 includes polymer fibers. In other embodiments, the textile scrim matrix 450 includes a rigid polymer body. In some embodiments, the textile scrim matrix 450 includes polyamide or polyester wool filament yarn. In still other embodiments, at least 50 percent of the fibers in the non-woven fiber blend 410 include para-aramid fibers. In other embodiments, at least 50 percent of the fibers in the non-woven fiber blend 410 include high-elongation polyester fibers. In still other embodiments, 50 percent or fewer of the fibers in the non-woven fiber blend 410 are nylon fibers. In some embodiments, fiber composition of the non-woven fiber blend 410 optimizes hardness, resilience, surface roughness, and sound-absorbing properties for pickleball. In some embodiments, the fiber composition of the non-woven fiber blend 410 is optimized for non-microbial properties.

According to some embodiments, a coating can be disposed on the exterior surface of the non-woven fiber blend 410. In other embodiments, the coating is disposed on the individual fibers 420 and 430. In some embodiments, the non-woven fiber blend 410 is coated with a protective acrylic. In other embodiments, the non-woven fiber blend 410 is coated with polyurethane. In other embodiments, the non-woven fiber blend 410 is coated with ethylene-vinyl acetate (EVA). In other embodiments, the non-woven fiber blend 410 is coated or infused with polyolefins, silicones, or other materials. The coatings may improve weather resistance, ultraviolet stability, durability, the coefficient of friction, and overall longevity of the non-woven fiber blend 410.

Various methods of manufacturing a pickleball paddle may be used. The method includes providing a pickleball paddle 100. The method further includes attaching a sound-absorbing cloth 122 to a striking surface 120 of the pickleball paddle 100. In some embodiments, the result of the aforementioned method results in a sound-absorbing pickleball paddle 100. In some embodiments, the method also includes attaching an adhesive backing of the sound-absorbing cloth 122 onto the striking surface 120 of the pickleball paddle 100. In other embodiments, the method includes wrapping the sound-absorbing cloth 122 around the striking surface 120 of the pickleball paddle 100. In other embodiments, a different method of fixing the sound-absorbing cloth 122 to the striking surface 120 may be used.

In some embodiments, methods of manufacturing the sound-absorbing cloth include water felting. Water felting uses agitation and compression in hot water to bind fibers together. In other embodiments, a needle may be used to bind fibers together to form the sound-absorbing cloth. In other embodiments, other felting methods are used.

According to embodiments disclosed herein, the sound-absorbing cloth 122 is operable to reduce the sound of a ball striking the pickleball paddle by more than (>) 3 decibels (db), >4 db, >5 db, >6 db, >7 db, >8 db, >9 db, >10 db, >11 db, >12 db, or other ranges and values disposed thereinbetween. For purposes of this disclosure, face deflection means the compression deformation of the striking surface 120 of a pickleball paddle 100 under a three-kilogram weight. Face deflection is determined by measuring the deformation displacement of the striking surface, usually in inches.

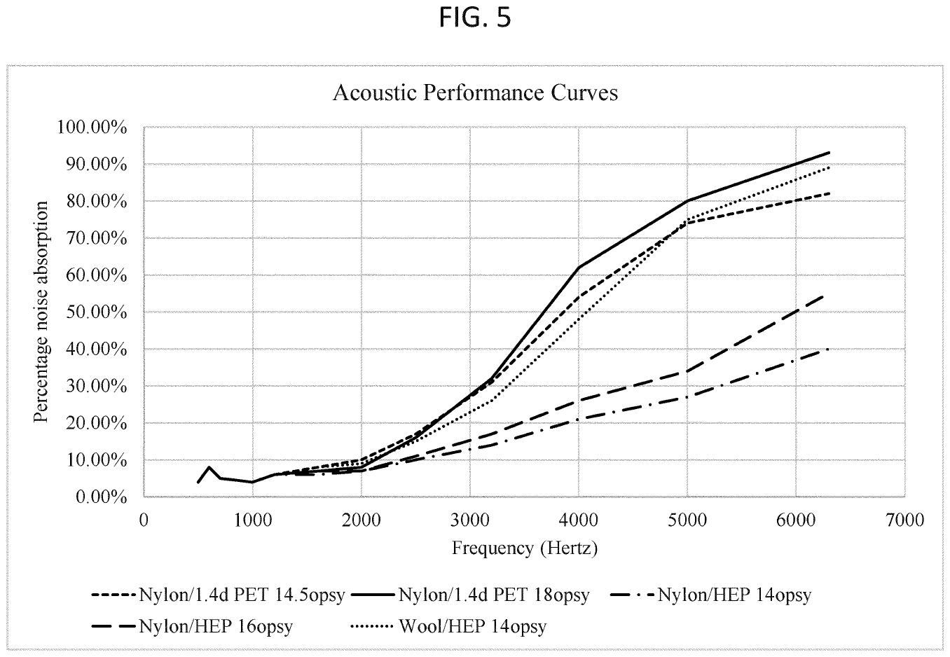

FIG. 5 illustrates acoustic performance curves of various compositions of sound-absorbing cloths (e.g., the sound-absorbing cloth 122). The x axis plots the sound frequency in Hertz and the y axis plots the percentage of noise absorption. As shown in FIG. 5, each of the sound-absorbing cloths have a similar sound absorption (under 10%) at sound frequencies below 2000 Hertz (hz). At frequencies between about 2000 hz and about 3000 hz, a nylon/polyethylene terephthalate (nylon/PET) blend having a weight of about 14.5 ounces per square yard (opsy) has the highest sound absorption, ranging from about 10% at 2000 hz to about 30% at 3000 hertz. At frequencies above 3000 hz, a nylon/high-elongation polyester (nylon/HEP) blend having a weight of about 18 opsy has the highest sound absorption, ranging from about 30% at 3000 hz to about 92% at about 6300 hz. A wool/HEP blend had a similar sound absorption performance, ranging from about 23% at 3000 hz to about 89% at about 6300 hz. A nylon/HEP blend having a weight of 16 opsy and another nylon/HEP blend having a weight of 14.5 opsy displayed lower sound absorption, ranging from under 10% at 2000 hz to 40% at about 6300 hz (14 opsy blend) and about 55% at 6300 hz (16 opsy blend). FIG. 5 illustrates that higher weight nylon/HEP blends (about 18 opsy) absorb more sound than lower weight nylon/HEP blends (about 14-16 opsy).

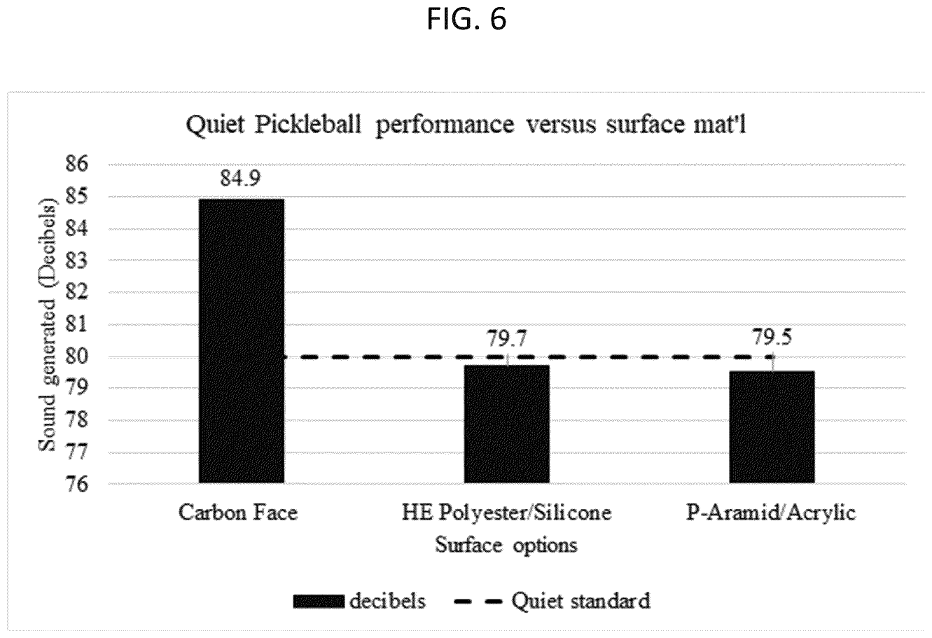

FIG. 6 illustrates sound performance of pickleball paddles without a sound-absorbing cloth (carbon face) and the sound performance of pickleball paddles with a sound-absorbing cloth (HE polyester/silicone and p-aramid/acrylic). As shown in FIG. 6, the threshold between loud paddles and quiet paddles is about 80 decibels. In other embodiments, the threshold is different for applications, for example, 75 decibels or 70 decibels for indoor play and/or 85 decibels or 90 decibels for outdoor play. As shown in FIG. 6, both high-elongation polyester/silicone and para-aramid/acrylic sound-absorbing cloths make sounds less than 80 decibels (79.7 decibels and 79.5 decibels, respectively), on average, when striking objects (e.g., pickleballs). As shown in FIG. 6, carbon faces (e.g., striking surfaces) make sounds greater than 80 decibels, on average (84.9 decibels).

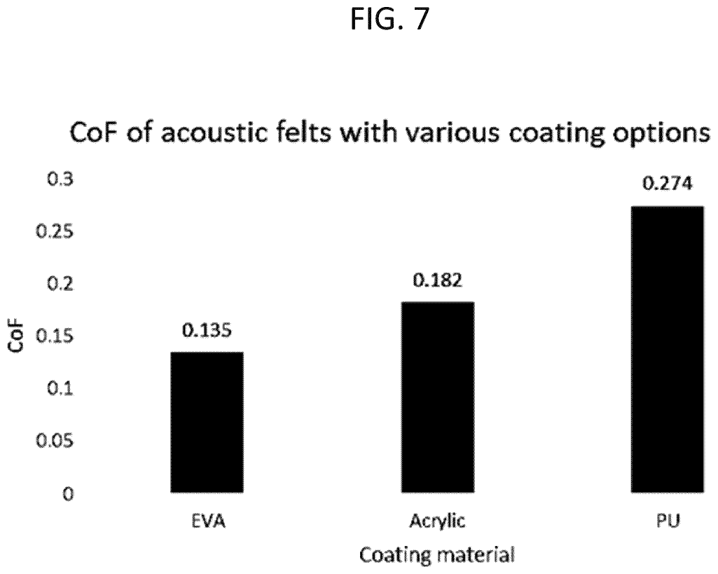

FIG. 7 illustrates the coefficient of frictions of acoustic felts with various coating options. A higher coefficient of friction can reduce wear and impact damage on a material. As shown in FIG. 7, EVA (ethyl-vinyl acetate) has a coefficient of friction of 0.135, acrylic coating materials have a coefficient of friction of 0.182, and PU (polyurethane) has a coefficient of friction of 0.274. In some embodiments, polyurethane experiences lower wear and impact damage over time compared to EVA and acrylic materials.

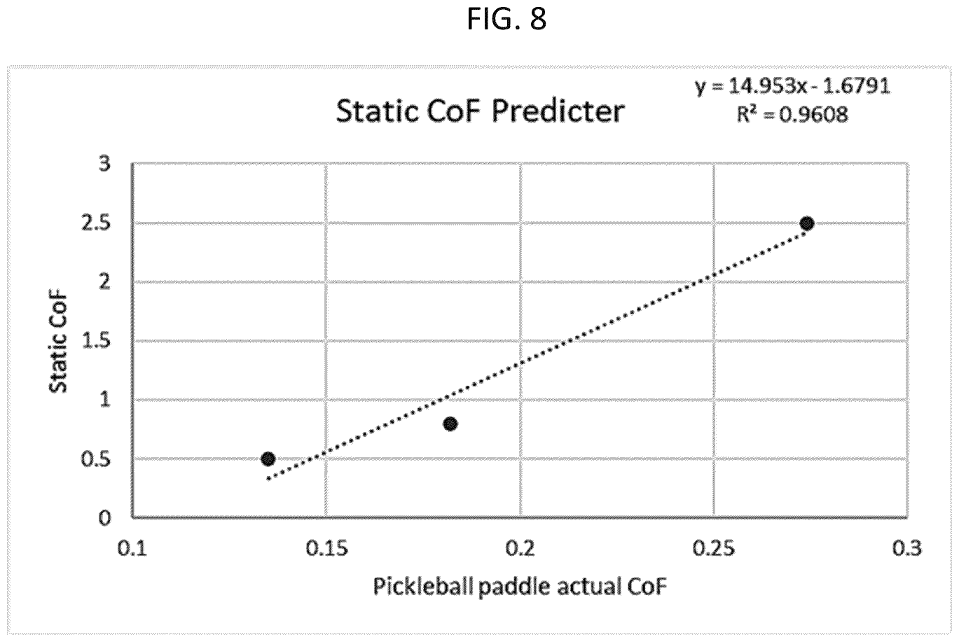

FIG. 8 illustrates a plot of the measured coefficient of friction of pickleball paddle surfaces (x-axis) versus the static coefficient of friction of the material itself. As shown in FIG. 8, the predicted coefficients of friction in FIG. 8 correlate to the measured coefficients of friction in FIG. 7. As shown in FIG. 8, EVA has a predicted coefficient of friction of 0.5 and a measure coefficient of friction of 0.135. As shown in FIG. 8, acrylic coating materials have a predicted coefficient of friction of about 0.8 and a measured coefficient of friction of 0.182. As shown in FIG. 8, PU has a predicted coefficient of friction of 2.5 and an actual coefficient of friction of 0.274.

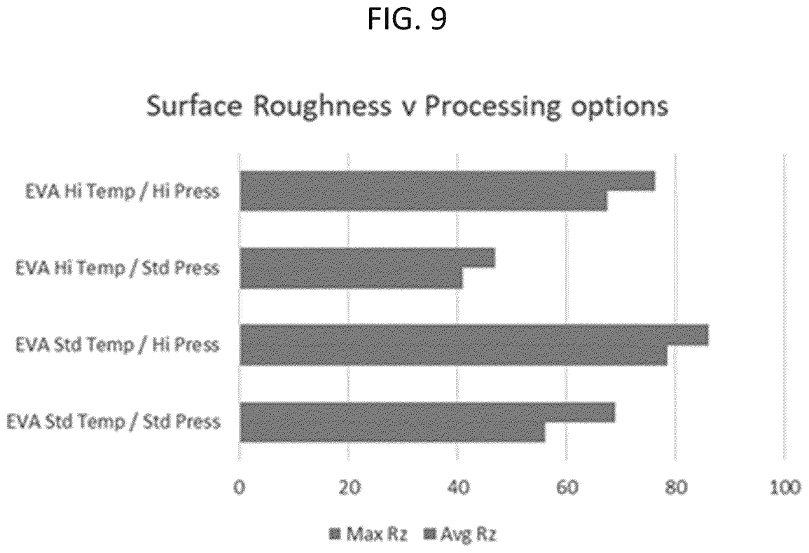

FIG. 9 illustrates the surface roughness of various sound-absorbing cloths. Each sound-absorbing cloth in FIG. 9 was manufactured with a different method. As shown in FIG. 9, EVA processed at high temperatures and high pressures has a maximum surface roughness of about 75 Rz and an average surface roughness of about 67 Rz. As shown in FIG. 9, EVA processed at high temperatures and standard pressures has a maximum surface roughness of about 46 Rz and an average surface roughness of about 41 Rz. As shown in FIG. 9, EVA processed at standard temperatures and high pressures has a maximum surface roughness of about 87 Rz and an average surface roughness of about 79 Rz. As shown in FIG. 9, EVA processed at standard temperatures and standard pressures has a maximum standard roughness of about 70 Rz and an average surface roughness of about 57 Rz.

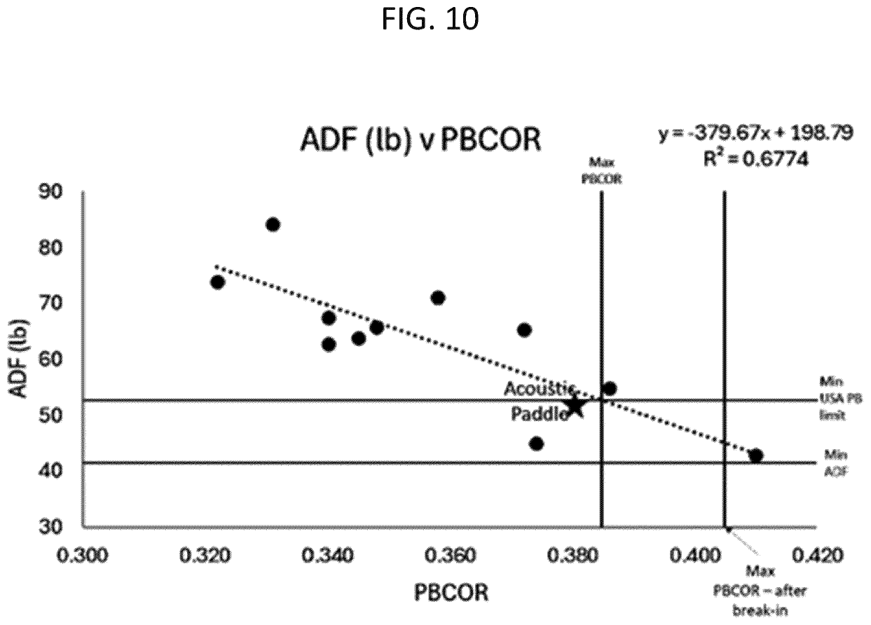

FIG. 10 illustrates the Paddle/Ball Coefficient of Restitution (PBCOR) of various paddles (x-axis) plotted versus the surface deflection (ADF). USA pickleball regulations require a maximum surface deflection of about 52 lbs and a minimum surface deflection of about 41 lbs. USA pickleball regulations further require a maximum PBCOR of about 0.390. As shown in FIG. 10, a sound-absorbing pickleball paddle complies with USA pickleball regulations.

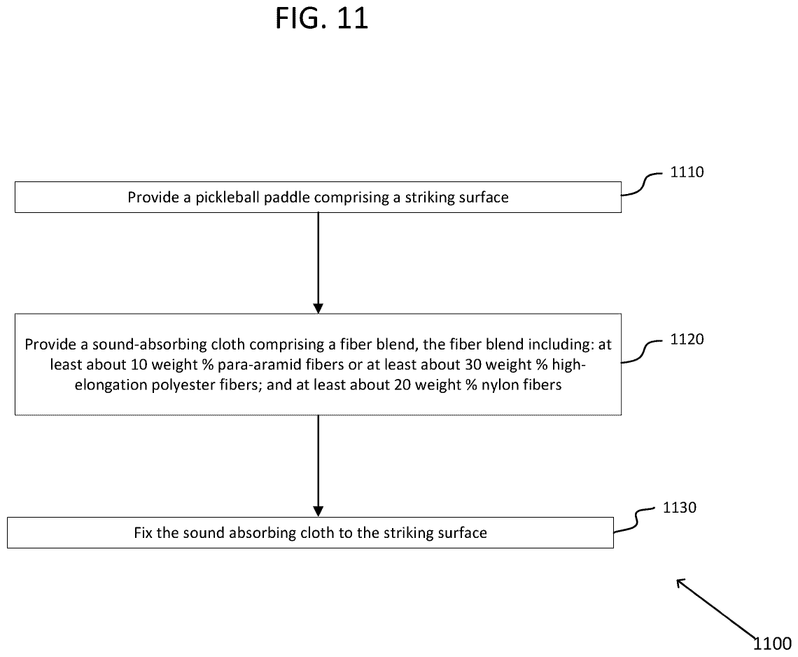

FIG. 11 illustrates a method 1100 of assembling a pickleball paddle. The method 1100 includes a first step 1110 of providing a pickleball paddle, such as the pickleball paddle 100. The pickleball paddle has a striking surface, such as the striking surface 120. The method 1100 includes a second step 1120 of providing a sound-absorbing cloth, such as the sound-absorbing cloth 122. The sound-absorbing cloth includes a fiber blend, such as the non-woven fiber blend 410. The fiber blend includes at least about 10 weight % para-aramid fibers or at least about 30 weight % high-elongation polyester fibers, and at least about 20 weight % nylon fibers. The method 1100 further includes a third step 1130 of fixing the sound-absorbing cloth the striking surface. For example, a user may remove a protective layer disposed over an adhesive backing on the sound-absorbing cloth and press the sound-absorbing cloth onto the striking surface. By way of another example, the sound-absorbing cloth is a wrap configured to be wrapped around the striking surface.

In some embodiments, the non-woven fiber blend includes about 10 weight percent (wt %) para-aramid fibers and 90 wt % nylon fibers, 11 wt % para-aramid fibers and 89 wt % nylon fibers, 12 wt % para-aramid fibers and 88 wt % nylon fibers, 13 wt % para-aramid fibers and 87 wt % nylon fibers, 14 wt % para-aramid fibers and 86 wt % nylon fibers, 15 wt % para-aramid fibers and 85 wt % nylon fibers, 16 wt % para-aramid fibers and 84 wt % nylon fibers, 17 wt % para-aramid fibers and 83 wt % nylon fibers, 18 wt % para-aramid fibers and 82 wt % nylon fibers, 19 wt % para-aramid fibers and 81 wt % nylon fibers, 20 wt % para-aramid fibers and 80 wt % nylon fibers, 21 wt % para-aramid fibers and 79 wt % nylon fibers, 22 wt % para-aramid fibers and 78 wt % nylon fibers, 23 wt % para-aramid fibers and 77 wt % nylon fibers, 24 wt % para-aramid fibers and 76 wt % nylon fibers, 25 wt % para-aramid fibers and 75 wt % nylon fibers, 26 wt % para-aramid fibers and 74 wt % nylon fibers, 27 wt % para-aramid fibers and 73 wt % nylon fibers, 28 wt % para-aramid fibers and 72 wt % nylon fibers, 29 wt % para-aramid fibers and 71 wt % nylon fibers, 30 wt % para-aramid fibers and 70 wt % nylon fibers, 31 wt % para-aramid fibers and 69 wt % nylon fibers, 32 wt % para-aramid fibers and 68 wt % nylon fibers, 33 wt % para-aramid fibers and 67 wt % nylon fibers, 34 wt % para-aramid fibers and 66 wt % nylon fibers, 35 wt % para-aramid fibers and 65 wt % nylon fibers, 36 wt % para-aramid fibers and 64 wt % nylon fibers, 37 wt % para-aramid fibers and 63 wt % nylon fibers, 38 wt % para-aramid fibers and 62 wt % nylon fibers, 39 wt % para-aramid fibers and 61 wt % nylon fibers, 40 wt % para-aramid fibers and 60 wt % nylon fibers, 41 wt % para-aramid fibers and 59 wt % nylon fibers, 42 wt % para-aramid fibers and 58 wt % nylon fibers, 43 wt % para-aramid fibers and 57 wt % nylon fibers, 44 wt % para-aramid fibers and 56 wt % nylon fibers, 45 wt % para-aramid fibers and 55 wt % nylon fibers, 46 wt % para-aramid fibers and 54 wt % nylon fibers, 47 wt % para-aramid fibers and 53 wt % nylon fibers, 48 wt % para-aramid fibers and 52 wt % nylon fibers, 49 wt % para-aramid fibers and 51 wt % nylon fibers, 50 wt % para-aramid fibers and 50 wt % nylon fibers, 51 wt % para-aramid fibers and 49 wt % nylon fibers, 52 wt % para-aramid fibers and 48 wt % nylon fibers, 53 wt % para-aramid fibers and 47 wt % nylon fibers, 54 wt % para-aramid fibers and 46 wt % nylon fibers, 55 wt % para-aramid fibers and 45 wt % nylon fibers, 56 wt % para-aramid fibers and 44 wt % nylon fibers, 57 wt % para-aramid fibers and 43 wt % nylon fibers, 58 wt % para-aramid fibers and 42 wt % nylon fibers, 59 wt % para-aramid fibers and 41 wt % nylon fibers, 60 wt % para-aramid fibers and 40 wt % nylon fibers, 61 wt % para-aramid fibers and 39 wt % nylon fibers, 62 wt % para-aramid fibers and 38 wt % nylon fibers, 63 wt % para-aramid fibers and 37 wt % nylon fibers, 64 wt % para-aramid fibers and 36 wt % nylon fibers, 65 wt % para-aramid fibers and 35 wt % nylon fibers, 66 wt % para-aramid fibers and 34 wt % nylon fibers, 67 wt % para-aramid fibers and 33 wt % nylon fibers, 68 wt % para-aramid fibers and 32 wt % nylon fibers, 69 wt % para-aramid fibers and 31 wt % nylon fibers, 70 wt % para-aramid fibers and 30 wt % nylon fibers, 71 wt % para-aramid fibers and 29 wt % nylon fibers, 72 wt % para-aramid fibers and 28 wt % nylon fibers, 73 wt % para-aramid fibers and 27 wt % nylon fibers, 74 wt % para-aramid fibers and 26 wt % nylon fibers, 75 wt % para-aramid fibers and 25 wt % nylon fibers, 76 wt % para-aramid fibers and 24 wt % nylon fibers, 77 wt % para-aramid fibers and 23 wt % nylon fibers, 78 wt % para-aramid fibers and 22 wt % nylon fibers, 79 wt % para-aramid fibers and 21 wt % nylon fibers, 80 wt % para-aramid fibers and 20 wt % nylon fibers, 81 wt % para-aramid fibers and 19 wt % nylon fibers, 82 wt % para-aramid fibers and 18 wt % nylon fibers, 83 wt % para-aramid fibers and 17 wt % nylon fibers, 84 wt % para-aramid fibers and 16 wt % nylon fibers, 85 wt % para-aramid fibers and 15 wt % nylon fibers, 86 wt % para-aramid fibers and 14 wt % nylon fibers, 87 wt % para-aramid fibers and 13 wt % nylon fibers, 88 wt % para-aramid fibers and 12 wt % nylon fibers, 89 wt % para-aramid fibers and 11 wt % nylon fibers, 90 wt % para-aramid fibers and 10 wt % nylon fibers, 91 wt % para-aramid fibers and 9 wt % nylon fibers, 92 wt % para-aramid fibers and 8 wt % nylon fibers, 93 wt % para-aramid fibers and 7 wt % nylon fibers, 94 wt % para-aramid fibers and 6 wt % nylon fibers, 95 wt % para-aramid fibers and 5 wt % nylon fibers, 96 wt % para-aramid fibers and 4 wt % nylon fibers, 97 wt % para-aramid fibers and 3 wt % nylon fibers, 98 wt % para-aramid fibers and 2 wt % nylon fibers, 99 wt % para-aramid fibers and 1 wt % nylon fibers, 100 wt % para-aramid fibers and 0 wt % nylon fibers, or any ranges and values thereinbetween.

In some embodiments, the non-woven fiber blend 410 includes about 100 wt % para-aramid fibers, 99.5 wt % para-aramid fibers, 99 wt % para-aramid fibers, 98.5 wt % para-aramid fibers, 98 wt % para-aramid fibers, 97.5 wt % para-aramid fibers, 97 wt % para-aramid fibers, 96.5 wt % para-aramid fibers, 96 wt % para-aramid fibers, 95.5 wt % para-aramid fibers, 95 wt % para-aramid fibers, 94.5 wt % para-aramid fibers, 94 wt % para-aramid fibers, 93.5 wt % para-aramid fibers, 93 wt % para-aramid fibers, 92.5 wt % para-aramid fibers, 92 wt % para-aramid fibers, 91.5 wt % para-aramid fibers, 91 wt % para-aramid fibers, 90.5 wt % para-aramid fibers, 90 wt % para-aramid fibers, 89.5 wt % para-aramid fibers, 89 wt % para-aramid fibers, 88.5 wt % para-aramid fibers, 88 wt % para-aramid fibers, 87.5 wt % para-aramid fibers, 87 wt % para-aramid fibers, 86.5 wt % para-aramid fibers, 86 wt % para-aramid fibers, 85.5 wt % para-aramid fibers, 85 wt % para-aramid fibers, 84.5 wt % para-aramid fibers, 84 wt % para-aramid fibers, 83.5 wt % para-aramid fibers, 83 wt % para-aramid fibers, 82.5 wt % para-aramid fibers, 82 wt % para-aramid fibers, 81.5 wt % para-aramid fibers, 81 wt % para-aramid fibers, 80.5 wt % para-aramid fibers, 80 wt % para-aramid fibers, 79.5 wt % para-aramid fibers, 79 wt % para-aramid fibers, 78.5 wt % para-aramid fibers, 78 wt % para-aramid fibers, 77.5 wt % para-aramid fibers, 77 wt % para-aramid fibers, 76.5 wt % para-aramid fibers, 76 wt % para-aramid fibers, 75.5 wt % para-aramid fibers, 75 wt % para-aramid fibers, 74.5 wt % para-aramid fibers, 74 wt % para-aramid fibers, 73.5 wt % para-aramid fibers, 73 wt % para-aramid fibers, 72.5 wt % para-aramid fibers, 72 wt % para-aramid fibers, 71.5 wt % para-aramid fibers, 71 wt % para-aramid fibers, 70.5 wt % para-aramid fibers, 70 wt % para-aramid fibers, 69.5 wt % para-aramid fibers, 69 wt % para-aramid fibers, 68.5 wt % para-aramid fibers, 68 wt % para-aramid fibers, 67.5 wt % para-aramid fibers, 67 wt % para-aramid fibers, 66.5 wt % para-aramid fibers, 66 wt % para-aramid fibers, 65.5 wt % para-aramid fibers, 65 wt % para-aramid fibers, 64.5 wt % para-aramid fibers, 64 wt % para-aramid fibers, 63.5 wt % para-aramid fibers, 63 wt % para-aramid fibers, 62.5 wt % para-aramid fibers, 62 wt % para-aramid fibers, 61.5 wt % para-aramid fibers, 61 wt % para-aramid fibers, 60.5 wt % para-aramid fibers, 60 wt % para-aramid fibers, 59.5 wt % para-aramid fibers, 59 wt % para-aramid fibers, 58.5 wt % para-aramid fibers, 58 wt % para-aramid fibers, 57.5 wt % para-aramid fibers, 57 wt % para-aramid fibers, 56.5 wt % para-aramid fibers, 56 wt % para-aramid fibers, 55.5 wt % para-aramid fibers, 55 wt % para-aramid fibers, 54.5 wt % para-aramid fibers, 54 wt % para-aramid fibers, 53.5 wt % para-aramid fibers, 53 wt % para-aramid fibers, 52.5 wt % para-aramid fibers, 52 wt % para-aramid fibers, 51.5 wt % para-aramid fibers, 51 wt % para-aramid fibers, 50.5 wt % para-aramid fibers, 50 wt % para-aramid fibers, 49.5 wt % para-aramid fibers, 49 wt % para-aramid fibers, 48.5 wt % para-aramid fibers, 48 wt % para-aramid fibers, 47.5 wt % para-aramid fibers, 47 wt % para-aramid fibers, 46.5 wt % para-aramid fibers, 46 wt % para-aramid fibers, 45.5 wt % para-aramid fibers, 45 wt % para-aramid fibers, 44.5 wt % para-aramid fibers, 44 wt % para-aramid fibers, 43.5 wt % para-aramid fibers, 43 wt % para-aramid fibers, 42.5 wt % para-aramid fibers, 42 wt % para-aramid fibers, 41.5 wt % para-aramid fibers, 41 wt % para-aramid fibers, 40.5 wt % para-aramid fibers, 40 wt % para-aramid fibers, 39.5 wt % para-aramid fibers, 39 wt % para-aramid fibers, 38.5 wt % para-aramid fibers, 38 wt % para-aramid fibers, 37.5 wt % para-aramid fibers, 37 wt % para-aramid fibers, 36.5 wt % para-aramid fibers, 36 wt % para-aramid fibers, 35.5 wt % para-aramid fibers, 35 wt % para-aramid fibers, 34.5 wt % para-aramid fibers, 34 wt % para-aramid fibers, 33.5 wt % para-aramid fibers, 33 wt % para-aramid fibers, 32.5 wt % para-aramid fibers, 32 wt % para-aramid fibers, 31.5 wt % para-aramid fibers, 31 wt % para-aramid fibers, 30.5 wt % para-aramid fibers, 30 wt % para-aramid fibers, 29.5 wt % para-aramid fibers, 29 wt % para-aramid fibers, 28.5 wt % para-aramid fibers, 28 wt % para-aramid fibers, 27.5 wt % para-aramid fibers, 27 wt % para-aramid fibers, 26.5 wt % para-aramid fibers, 26 wt % para-aramid fibers, 25.5 wt % para-aramid fibers, 25 wt % para-aramid fibers, 24.5 wt % para-aramid fibers, 24 wt % para-aramid fibers, 23.5 wt % para-aramid fibers, 23 wt % para-aramid fibers, 22.5 wt % para-aramid fibers, 22 wt % para-aramid fibers, 21.5 wt % para-aramid fibers, 21 wt % para-aramid fibers, 20.5 wt % para-aramid fibers, 20 wt % para-aramid fibers, 19.5 wt % para-aramid fibers, 19 wt % para-aramid fibers, 18.5 wt % para-aramid fibers, 18 wt % para-aramid fibers, 17.5 wt % para-aramid fibers, 17 wt % para-aramid fibers, 16.5 wt % para-aramid fibers, 16 wt % para-aramid fibers, 15.5 wt % para-aramid fibers, 15 wt % para-aramid fibers, 14.5 wt % para-aramid fibers, 14 wt % para-aramid fibers, 13.5 wt % para-aramid fibers, 13 wt % para-aramid fibers, 12.5 wt % para-aramid fibers, 12 wt % para-aramid fibers, 11.5 wt % para-aramid fibers, 11 wt % para-aramid fibers, 10.5 wt % para-aramid fibers, 10 wt % para-aramid fibers, 9.5 wt % para-aramid fibers, 9 wt % para-aramid fibers, 8.5 wt % para-aramid fibers, 8 wt % para-aramid fibers, 7.5 wt % para-aramid fibers, 7 wt % para-aramid fibers, 6.5 wt % para-aramid fibers, 6 wt % para-aramid fibers, 5.5 wt % para-aramid fibers, 5 wt % para-aramid fibers, 4.5 wt % para-aramid fibers, 4 wt % para-aramid fibers, 3.5 wt % para-aramid fibers, 3 wt % para-aramid fibers, 2.5 wt % para-aramid fibers, 2 wt % para-aramid fibers, 1.5 wt % para-aramid fibers, 1 wt % para-aramid fibers, 0.5 wt % para-aramid fibers, 0 wt % para-aramid fibers, or any ranges and values thereinbetween.

In some embodiments, the non-woven fiber blend 410 includes about 100 wt % nylon fibers, 99.5 wt % nylon fibers, 99 wt % nylon fibers, 98.5 wt % nylon fibers, 98 wt % nylon fibers, 97.5 wt % nylon fibers, 97 wt % nylon fibers, 96.5 wt % nylon fibers, 96 wt % nylon fibers, 95.5 wt % nylon fibers, 95 wt % nylon fibers, 94.5 wt % nylon fibers, 94 wt % nylon fibers, 93.5 wt % nylon fibers, 93 wt % nylon fibers, 92.5 wt % nylon fibers, 92 wt % nylon fibers, 91.5 wt % nylon fibers, 91 wt % nylon fibers, 90.5 wt % nylon fibers, 90 wt % nylon fibers, 89.5 wt % nylon fibers, 89 wt % nylon fibers, 88.5 wt % nylon fibers, 88 wt % nylon fibers, 87.5 wt % nylon fibers, 87 wt % nylon fibers, 86.5 wt % nylon fibers, 86 wt % nylon fibers, 85.5 wt % nylon fibers, 85 wt % nylon fibers, 84.5 wt % nylon fibers, 84 wt % nylon fibers, 83.5 wt % nylon fibers, 83 wt % nylon fibers, 82.5 wt % nylon fibers, 82 wt % nylon fibers, 81.5 wt % nylon fibers, 81 wt % nylon fibers, 80.5 wt % nylon fibers, 80 wt % nylon fibers, 79.5 wt % nylon fibers, 79 wt % nylon fibers, 78.5 wt % nylon fibers, 78 wt % nylon fibers, 77.5 wt % nylon fibers, 77 wt % nylon fibers, 76.5 wt % nylon fibers, 76 wt % nylon fibers, 75.5 wt % nylon fibers, 75 wt % nylon fibers, 74.5 wt % nylon fibers, 74 wt % nylon fibers, 73.5 wt % nylon fibers, 73 wt % nylon fibers, 72.5 wt % nylon fibers, 72 wt % nylon fibers, 71.5 wt % nylon fibers, 71 wt % nylon fibers, 70.5 wt % nylon fibers, 70 wt % nylon fibers, 69.5 wt % nylon fibers, 69 wt % nylon fibers, 68.5 wt % nylon fibers, 68 wt % nylon fibers, 67.5 wt % nylon fibers, 67 wt % nylon fibers, 66.5 wt % nylon fibers, 66 wt % nylon fibers, 65.5 wt % nylon fibers, 65 wt % nylon fibers, 64.5 wt % nylon fibers, 64 wt % nylon fibers, 63.5 wt % nylon fibers, 63 wt % nylon fibers, 62.5 wt % nylon fibers, 62 wt % nylon fibers, 61.5 wt % nylon fibers, 61 wt % nylon fibers, 60.5 wt % nylon fibers, 60 wt % nylon fibers, 59.5 wt % nylon fibers, 59 wt % nylon fibers, 58.5 wt % nylon fibers, 58 wt % nylon fibers, 57.5 wt % nylon fibers, 57 wt % nylon fibers, 56.5 wt % nylon fibers, 56 wt % nylon fibers, 55.5 wt % nylon fibers, 55 wt % nylon fibers, 54.5 wt % nylon fibers, 54 wt % nylon fibers, 53.5 wt % nylon fibers, 53 wt % nylon fibers, 52.5 wt % nylon fibers, 52 wt % nylon fibers, 51.5 wt % nylon fibers, 51 wt % nylon fibers, 50.5 wt % nylon fibers, 50 wt % nylon fibers, 49.5 wt % nylon fibers, 49 wt % nylon fibers, 48.5 wt % nylon fibers, 48 wt % nylon fibers, 47.5 wt % nylon fibers, 47 wt % nylon fibers, 46.5 wt % nylon fibers, 46 wt % nylon fibers, 45.5 wt % nylon fibers, 45 wt % nylon fibers, 44.5 wt % nylon fibers, 44 wt % nylon fibers, 43.5 wt % nylon fibers, 43 wt % nylon fibers, 42.5 wt % nylon fibers, 42 wt % nylon fibers, 41.5 wt % nylon fibers, 41 wt % nylon fibers, 40.5 wt % nylon fibers, 40 wt % nylon fibers, 39.5 wt % nylon fibers, 39 wt % nylon fibers, 38.5 wt % nylon fibers, 38 wt % nylon fibers, 37.5 wt % nylon fibers, 37 wt % nylon fibers, 36.5 wt % nylon fibers, 36 wt % nylon fibers, 35.5 wt % nylon fibers, 35 wt % nylon fibers, 34.5 wt % nylon fibers, 34 wt % nylon fibers, 33.5 wt % nylon fibers, 33 wt % nylon fibers, 32.5 wt % nylon fibers, 32 wt % nylon fibers, 31.5 wt % nylon fibers, 31 wt % nylon fibers, 30.5 wt % nylon fibers, 30 wt % nylon fibers, 29.5 wt % nylon fibers, 29 wt % nylon fibers, 28.5 wt % nylon fibers, 28 wt % nylon fibers, 27.5 wt % nylon fibers, 27 wt % nylon fibers, 26.5 wt % nylon fibers, 26 wt % nylon fibers, 25.5 wt % nylon fibers, 25 wt % nylon fibers, 24.5 wt % nylon fibers, 24 wt % nylon fibers, 23.5 wt % nylon fibers, 23 wt % nylon fibers, 22.5 wt % nylon fibers, 22 wt % nylon fibers, 21.5 wt % nylon fibers, 21 wt % nylon fibers, 20.5 wt % nylon fibers, 20 wt % nylon fibers, 19.5 wt % nylon fibers, 19 wt % nylon fibers, 18.5 wt % nylon fibers, 18 wt % nylon fibers, 17.5 wt % nylon fibers, 17 wt % nylon fibers, 16.5 wt % nylon fibers, 16 wt % nylon fibers, 15.5 wt % nylon fibers, 15 wt % nylon fibers, 14.5 wt % nylon fibers, 14 wt % nylon fibers, 13.5 wt % nylon fibers, 13 wt % nylon fibers, 12.5 wt % nylon fibers, 12 wt % nylon fibers, 11.5 wt % nylon fibers, 11 wt % nylon fibers, 10.5 wt % nylon fibers, 10 wt % nylon fibers, 9.5 wt % nylon fibers, 9 wt % nylon fibers, 8.5 wt % nylon fibers, 8 wt % nylon fibers, 7.5 wt % nylon fibers, 7 wt % nylon fibers, 6.5 wt % nylon fibers, 6 wt % nylon fibers, 5.5 wt % nylon fibers, 5 wt % nylon fibers, 4.5 wt % nylon fibers, 4 wt % nylon fibers, 3.5 wt % nylon fibers, 3 wt % nylon fibers, 2.5 wt % nylon fibers, 2 wt % nylon fibers, 1.5 wt % nylon fibers, 1 wt % nylon fibers, 0.5 wt % nylon fibers, 0 wt % nylon fibers, or any ranges and values thereinbetween.

In some embodiments, the non-woven fiber blend 410 includes about 100 wt % high-elongation polyester fibers, 99.5 wt % high-elongation polyester fibers, 99 wt % high-elongation polyester fibers, 98.5 wt % high-elongation polyester fibers, 98 wt % high-elongation polyester fibers, 97.5 wt % high-elongation polyester fibers, 97 wt % high-elongation polyester fibers, 96.5 wt % high-elongation polyester fibers, 96 wt % high-elongation polyester fibers, 95.5 wt % high-elongation polyester fibers, 95 wt % high-elongation polyester fibers, 94.5 wt % high-elongation polyester fibers, 94 wt % high-elongation polyester fibers, 93.5 wt % high-elongation polyester fibers, 93 wt % high-elongation polyester fibers, 92.5 wt % high-elongation polyester fibers, 92 wt % high-elongation polyester fibers, 91.5 wt % high-elongation polyester fibers, 91 wt % high-elongation polyester fibers, 90.5 wt % high-elongation polyester fibers, 90 wt % high-elongation polyester fibers, 89.5 wt % high-elongation polyester fibers, 89 wt % high-elongation polyester fibers, 88.5 wt % high-elongation polyester fibers, 88 wt % high-elongation polyester fibers, 87.5 wt % high-elongation polyester fibers, 87 wt % high-elongation polyester fibers, 86.5 wt % high-elongation polyester fibers, 86 wt % high-elongation polyester fibers, 85.5 wt % high-elongation polyester fibers, 85 wt % high-elongation polyester fibers, 84.5 wt % high-elongation polyester fibers, 84 wt % high-elongation polyester fibers, 83.5 wt % high-elongation polyester fibers, 83 wt % high-elongation polyester fibers, 82.5 wt % high-elongation polyester fibers, 82 wt % high-elongation polyester fibers, 81.5 wt % high-elongation polyester fibers, 81 wt % high-elongation polyester fibers, 80.5 wt % high-elongation polyester fibers, 80 wt % high-elongation polyester fibers, 79.5 wt % high-elongation polyester fibers, 79 wt % high-elongation polyester fibers, 78.5 wt % high-elongation polyester fibers, 78 wt % high-elongation polyester fibers, 77.5 wt % high-elongation polyester fibers, 77 wt % high-elongation polyester fibers, 76.5 wt % high-elongation polyester fibers, 76 wt % high-elongation polyester fibers, 75.5 wt % high-elongation polyester fibers, 75 wt % high-elongation polyester fibers, 74.5 wt % high-elongation polyester fibers, 74 wt % high-elongation polyester fibers, 73.5 wt % high-elongation polyester fibers, 73 wt % high-elongation polyester fibers, 72.5 wt % high-elongation polyester fibers, 72 wt % high-elongation polyester fibers, 71.5 wt % high-elongation polyester fibers, 71 wt % high-elongation polyester fibers, 70.5 wt % high-elongation polyester fibers, 70 wt % high-elongation polyester fibers, 69.5 wt % high-elongation polyester fibers, 69 wt % high-elongation polyester fibers, 68.5 wt % high-elongation polyester fibers, 68 wt % high-elongation polyester fibers, 67.5 wt % high-elongation polyester fibers, 67 wt % high-elongation polyester fibers, 66.5 wt % high-elongation polyester fibers, 66 wt % high-elongation polyester fibers, 65.5 wt % high-elongation polyester fibers, 65 wt % high-elongation polyester fibers, 64.5 wt % high-elongation polyester fibers, 64 wt % high-elongation polyester fibers, 63.5 wt % high-elongation polyester fibers, 63 wt % high-elongation polyester fibers, 62.5 wt % high-elongation polyester fibers, 62 wt % high-elongation polyester fibers, 61.5 wt % high-elongation polyester fibers, 61 wt % high-elongation polyester fibers, 60.5 wt % high-elongation polyester fibers, 60 wt % high-elongation polyester fibers, 59.5 wt % high-elongation polyester fibers, 59 wt % high-elongation polyester fibers, 58.5 wt % high-elongation polyester fibers, 58 wt % high-elongation polyester fibers, 57.5 wt % high-elongation polyester fibers, 57 wt % high-elongation polyester fibers, 56.5 wt % high-elongation polyester fibers, 56 wt % high-elongation polyester fibers, 55.5 wt % high-elongation polyester fibers, 55 wt % high-elongation polyester fibers, 54.5 wt % high-elongation polyester fibers, 54 wt % high-elongation polyester fibers, 53.5 wt % high-elongation polyester fibers, 53 wt % high-elongation polyester fibers, 52.5 wt % high-elongation polyester fibers, 52 wt % high-elongation polyester fibers, 51.5 wt % high-elongation polyester fibers, 51 wt % high-elongation polyester fibers, 50.5 wt % high-elongation polyester fibers, 50 wt % high-elongation polyester fibers, 49.5 wt % high-elongation polyester fibers, 49 wt % high-elongation polyester fibers, 48.5 wt % high-elongation polyester fibers, 48 wt % high-elongation polyester fibers, 47.5 wt % high-elongation polyester fibers, 47 wt % high-elongation polyester fibers, 46.5 wt % high-elongation polyester fibers, 46 wt % high-elongation polyester fibers, 45.5 wt % high-elongation polyester fibers, 45 wt % high-elongation polyester fibers, 44.5 wt % high-elongation polyester fibers, 44 wt % high-elongation polyester fibers, 43.5 wt % high-elongation polyester fibers, 43 wt % high-elongation polyester fibers, 42.5 wt % high-elongation polyester fibers, 42 wt % high-elongation polyester fibers, 41.5 wt % high-elongation polyester fibers, 41 wt % high-elongation polyester fibers, 40.5 wt % high-elongation polyester fibers, 40 wt % high-elongation polyester fibers, 39.5 wt % high-elongation polyester fibers, 39 wt % high-elongation polyester fibers, 38.5 wt % high-elongation polyester fibers, 38 wt % high-elongation polyester fibers, 37.5 wt % high-elongation polyester fibers, 37 wt % high-elongation polyester fibers, 36.5 wt % high-elongation polyester fibers, 36 wt % high-elongation polyester fibers, 35.5 wt % high-elongation polyester fibers, 35 wt % high-elongation polyester fibers, 34.5 wt % high-elongation polyester fibers, 34 wt % high-elongation polyester fibers, 33.5 wt % high-elongation polyester fibers, 33 wt % high-elongation polyester fibers, 32.5 wt % high-elongation polyester fibers, 32 wt % high-elongation polyester fibers, 31.5 wt % high-elongation polyester fibers, 31 wt % high-elongation polyester fibers, 30.5 wt % high-elongation polyester fibers, 30 wt % high-elongation polyester fibers, 29.5 wt % high-elongation polyester fibers, 29 wt % high-elongation polyester fibers, 28.5 wt % high-elongation polyester fibers, 28 wt % high-elongation polyester fibers, 27.5 wt % high-elongation polyester fibers, 27 wt % high-elongation polyester fibers, 26.5 wt % high-elongation polyester fibers, 26 wt % high-elongation polyester fibers, 25.5 wt % high-elongation polyester fibers, 25 wt % high-elongation polyester fibers, 24.5 wt % high-elongation polyester fibers, 24 wt % high-elongation polyester fibers, 23.5 wt % high-elongation polyester fibers, 23 wt % high-elongation polyester fibers, 22.5 wt % high-elongation polyester fibers, 22 wt % high-elongation polyester fibers, 21.5 wt % high-elongation polyester fibers, 21 wt % high-elongation polyester fibers, 20.5 wt % high-elongation polyester fibers, 20 wt % high-elongation polyester fibers, 19.5 wt % high-elongation polyester fibers, 19 wt % high-elongation polyester fibers, 18.5 wt % high-elongation polyester fibers, 18 wt % high-elongation polyester fibers, 17.5 wt % high-elongation polyester fibers, 17 wt % high-elongation polyester fibers, 16.5 wt % high-elongation polyester fibers, 16 wt % high-elongation polyester fibers, 15.5 wt % high-elongation polyester fibers, 15 wt % high-elongation polyester fibers, 14.5 wt % high-elongation polyester fibers, 14 wt % high-elongation polyester fibers, 13.5 wt % high-elongation polyester fibers, 13 wt % high-elongation polyester fibers, 12.5 wt % high-elongation polyester fibers, 12 wt % high-elongation polyester fibers, 11.5 wt % high-elongation polyester fibers, 11 wt % high-elongation polyester fibers, 10.5 wt % high-elongation polyester fibers, 10 wt % high-elongation polyester fibers, 9.5 wt % high-elongation polyester fibers, 9 wt % high-elongation polyester fibers, 8.5 wt % high-elongation polyester fibers, 8 wt % high-elongation polyester fibers, 7.5 wt % high-elongation polyester fibers, 7 wt % high-elongation polyester fibers, 6.5 wt % high-elongation polyester fibers, 6 wt % high-elongation polyester fibers, 5.5 wt % high-elongation polyester fibers, 5 wt % high-elongation polyester fibers, 4.5 wt % high-elongation polyester fibers, 4 wt % high-elongation polyester fibers, 3.5 wt % high-elongation polyester fibers, 3 wt % high-elongation polyester fibers, 2.5 wt % high-elongation polyester fibers, 2 wt % high-elongation polyester fibers, 1.5 wt % high-elongation polyester fibers, 1 wt % high-elongation polyester fibers, 0.5 wt % high-elongation polyester fibers, and 0 wt % high-elongation polyester fibers, or any ranges and values thereinbetween.

The polyester fibers, or any of the fibers disposed in the textile scrim matrix can have a combined or individual weight of about 2.0 ounces per square yard (opsy), 2.1 opsy, 2.2 opsy, 2.3 opsy, 2.4 opsy, 2.5 opsy, 2.6 opsy, 2.7 opsy, 2.8 opsy, 2.9 opsy, 3.0 opsy, 3.1 opsy, 3.2 opsy, 3.3 opsy, 3.4 opsy, 3.5 opsy, 3.6 opsy, 3.7 opsy, 3.8 opsy, 3.9 opsy, 4.0 opsy, 4.1 opsy, 4.2 opsy, 4.3 opsy, 4.4 opsy, 4.5 opsy, 4.6 opsy, 4.7 opsy, 4.8 opsy, 4.9 opsy, 5.0 opsy, 5.1 opsy, 5.2 opsy, 5.3 opsy, 5.4 opsy, 5.5 opsy, 5.6 opsy, 5.7 opsy, 5.8 opsy, 5.9 opsy, 6.0 opsy, 6.1 opsy, 6.2 opsy, 6.3 opsy, 6.4 opsy, 6.5 opsy, 6.6 opsy, 6.7 opsy, 6.8 opsy, 6.9 opsy, 7.0 opsy, 7.1 opsy, 7.2 opsy, 7.3 opsy, 7.4 opsy, 7.5 opsy, 7.6 opsy, 7.7 opsy, 7.8 opsy, 7.9 opsy, 8.0 opsy, 8.1 opsy, 8.2 opsy, 8.3 opsy, 8.4 opsy, 8.5 opsy, 8.6 opsy, 8.7 opsy, 8.8 opsy, 8.9 opsy, 9.0 opsy, 9.1 opsy, 9.2 opsy, 9.3 opsy, 9.4 opsy, 9.5 opsy, 9.6 opsy, 9.7 opsy, 9.8 opsy, 9.9 opsy, 10.0 opsy, 10.1 opsy, 10.2 opsy, 10.3 opsy, 10.4 opsy, 10.5 opsy, 10.6 opsy, 10.7 opsy, 10.8 opsy, 10.9 opsy, 11.0 opsy, 11.1 opsy, 11.1 opsy, 11.2 opsy, 11.3 opsy, 11.4 opsy, 11.5 opsy, 11.6 opsy, 11.7 opsy, 11.8 opsy, 11.9 opsy, 12.0 opsy, 12.1 opsy, 12.2 opsy, 12.3 opsy, 12.4 opsy, 12.5 opsy, 12.6 opsy, 12.7 opsy, 12.8 opsy, 12.9 opsy, 13.0 opsy, 13.1 opsy, 13.2 opsy, 13.3 opsy, 13.4 opsy, 13.5 opsy, 13.6 opsy, 13.7 opsy, 13.8 opsy, 13.9 opsy, 14.0 opsy, 14.1 opsy, 14.2 opsy, 14.3 opsy, 14.4 opsy, 14.5 opsy, 14.6 opsy, 14.7 opsy, 14.8 opsy, 14.9 opsy, 15.0 opsy, 15.1 opsy, 15.2 opsy, 15.3 opsy, 15.4 opsy, 15.5 opsy, 15.6 opsy, 15.7 opsy, 15.8 opsy, 15.9 opsy, 16.0 opsy, 16.1 opsy, 16.2 opsy, 16.3 opsy, 16.4 opsy, 16.5 opsy, 16.6 opsy, 16.7 opsy, 16.8 opsy, 16.9 opsy, 17.0 opsy, 17.1 opsy, 17.2 opsy, 17.3 opsy, 17.4 opsy, 17.5 opsy, 17.6 opsy, 17.7 opsy, 17.8 opsy, 17.9 opsy, 18.0 opsy, 18.1 opsy, 18.2 opsy, 18.3 opsy, 18.4 opsy, 18.5 opsy, 18.6 opsy, 18.7 opsy, 18.8 opsy, 18.9 opsy, 19.0 opsy, 19.1 opsy, 19.2 opsy, 19.3 opsy, 19.4 opsy, 19.5 opsy, 19.6 opsy, 19.7 opsy, 19.8 opsy, 19.9 opsy, 20.0 opsy, 20.1 opsy, 20.2 opsy, 20.3 opsy, 20.4 opsy, 20.5 opsy, 20.6 opsy, 20.7 opsy, 20.8 opsy, 20.9 opsy, 21.0 opsy, 21.1 opsy, 21.2 opsy, 21.3 opsy, 21.4 opsy, 21.5 opsy, 21.6 opsy, 21.7 opsy, 21.8 opsy, 21.9 opsy, 22.0 opsy, 22.1 opsy, 22.2 opsy, 22.3 opsy, 22.4 opsy, 22.5 opsy, 22.6 opsy, 22.7 opsy, 22.8 opsy, 22.9 opsy, 23.0 opsy, 23.1 opsy, 23.2 opsy, 23.3 opsy, 23.4 opsy, 23.5 opsy, 23.6 opsy, 23.7 opsy, 23.8 opsy, 23.9 opsy, 24.0 opsy, 24.1 opsy, 24.2 opsy, 24.3 opsy, 24.4 opsy, 24.5 opsy, 24.6 opsy, 24.7 opsy, 24.8 opsy, 24.9 opsy, 25.0 opsy, 25.1 opsy, 25.2 opsy, 25.3 opsy, 25.4 opsy, 25.5 opsy, 25.6 opsy, 25.7 opsy, 25.8 opsy, 25.9 opsy, 26.0 opsy, 26.1 opsy, 26.2 opsy, 26.3 opsy, 26.4 opsy, 26.5 opsy, 26.6 opsy, 26.7 opsy, 26.8 opsy, 26.9 opsy, 27.0 opsy, 27.1 opsy, 27.2 opsy, 27.3 opsy, 27.4 opsy, 27.5 opsy, 27.6 opsy, 27.7 opsy, 27.8 opsy, 27.9 opsy, 28.0 opsy, 28.1 opsy, 28.2 opsy, 28.3 opsy, 28.4 opsy, 28.5 opsy, 28.3 opsy, 28.4 opsy, 28.5 opsy, 28.6 opsy, 28.7 opsy, 28.8 opsy, 28.9 opsy, 29.0 opsy, 29.1 opsy, 29.2 opsy, 29.3 opsy, 29.4 opsy, 29.5 opsy, 29.6 opsy, 29.7 opsy, 29.8 opsy, 29.9 opsy, 30.0 opsy, or other ranges and values thereinbetween.

In some embodiments, the fiber matrix includes an EVA coating. The EVA coating can be about 0.25 wt %, 0.5 wt %, 1 wt %, 2 wt %, 3 wt %, 4 wt %, 5 wt %, 6 wt %, 7 wt %, 8 wt %, 9 wt %, 10 wt %, or other ranges and values disposed thereinbetween of the total weight percent of the fiber matrix. In some embodiments, the fiber matrix includes a polyurethane coating. The polyurethane coating can be about 0.25 wt %, 0.5 wt %, 1 wt %, 2 wt %, 3 wt %, 4 wt %, 5 wt %, 6 wt %, 7 wt %, 8 wt %, 9 wt %, 10 wt %, or other ranges and values disposed thereinbetween of the total weight percent of the fiber matrix. In some embodiments, the fiber matrix includes a coating including a combination of EVA and polyurethane. For example, the weight ratio of EVA to polyurethane can be about 1/99, 5/95, 10/90, 20/80, 30/70, 40/60, 50/50, 60/40, 70/30, 80/20, 90/10, 95/5, 99/1, or other ranges and values disposed thereinbetween.

According to some embodiments, the striking body 110 can be formed of wood, graphite, carbon fiber, polymers, other carbon composite materials and/or combinations thereof. For example, the striking body can be formed of 90 wt % carbon fiber and 10 wt % polymers; 10 wt % carbon fiber and 90 wt % polymers; about 33 wt % carbon fiber, 33 wt % polymers, and 33 wt % graphite; 90 wt % wood and 10 wt % graphite; or other combinations thereof. In some embodiments, the handle 130 includes a rubber or synthetic material. In some embodiments, the handle 130 may include at least 10 wt % polyurethane.

In some embodiments, the sound-absorbing cloth and the fiber matrix include wool fibers. For example, the wool fibers can be at least about 20 weight % (wt %) of the fiber matrix, or the fiber matrix can include at least about 1 wt % wool fibers, 1 wt % wool fibers, 2 wt % wool fibers, 3 wt % wool fibers, 4 wt % wool fibers, 5 wt % wool fibers, 6 wt % wool fibers, 7 wt % wool fibers, 8 wt % wool fibers, 9 wt % wool fibers, 10 wt % wool fibers, 11 wt % wool fibers, 12 wt % wool fibers, 13 wt % wool fibers, 14 wt % wool fibers, 15 wt % wool fibers, 16 wt % wool fibers, 17 wt % wool fibers, 18 wt % wool fibers, 19 wt % wool fibers, 20 wt % wool fibers, 21 wt % wool fibers, 22 wt % wool fibers, 23 wt % wool fibers, 24 wt % wool fibers, 25 wt % wool fibers, 26 wt % wool fibers, 27 wt % wool fibers, 28 wt % wool fibers, 29 wt % wool fibers, 30 wt % wool fibers, 31 wt % wool fibers, 32 wt % wool fibers, 33 wt % wool fibers, 34 wt % wool fibers, 35 wt % wool fibers, 36 wt % wool fibers, 37 wt % wool fibers, 38 wt % wool fibers, 39 wt % wool fibers, 40 wt % wool fibers, 41 wt % wool fibers, 42 wt % wool fibers, 43 wt % wool fibers, 44 wt % wool fibers, 45 wt % wool fibers, 46 wt % wool fibers, 47 wt % wool fibers, 48 wt % wool fibers, 49 wt % wool fibers, 50 wt % wool fibers, 51 wt % wool fibers, 52 wt % wool fibers, 53 wt % wool fibers, 54 wt % wool fibers, 55 wt % wool fibers, 56 wt % wool fibers, 57 wt % wool fibers, 58 wt % wool fibers, 59 wt % wool fibers, 60 wt % wool fibers, 61 wt % wool fibers, 62 wt % wool fibers, 63 wt % wool fibers, 64 wt % wool fibers, 65 wt % wool fibers, 66 wt % wool fibers, 67 wt % wool fibers, 68 wt % wool fibers, 69 wt % wool fibers, 70 wt % wool fibers, 71 wt % wool fibers, 72 wt % wool fibers, 73 wt % wool fibers, 74 wt % wool fibers, 75 wt % wool fibers, 76 wt % wool fibers, 77 wt % wool fibers, 78 wt % wool fibers, 79 wt % wool fibers, 80 wt % wool fibers, 81 wt % wool fibers, 82 wt % wool fibers, 83 wt % wool fibers, 84 wt % wool fibers, 85 wt % wool fibers, 86 wt % wool fibers, 87 wt % wool fibers, 88 wt % wool fibers, 89 wt % wool fibers, 90 wt % wool fibers, 91 wt % wool fibers, 92 wt % wool fibers, 93 wt % wool fibers, 94 wt % wool fibers, 95 wt % wool fibers, 96 wt % wool fibers, 97 wt % wool fibers, 98 wt % wool fibers, 99 wt % wool fibers, 100 wt % wool fibers, or any ranges and values disposed thereinbetween.

In some embodiments, the sound-absorbing cloth and the fiber matrix include polyethylene terephthalate (PET) fibers. For example, the PET fibers can be at least about 20 weight % (wt %) of the fiber matrix, or the fiber matrix can include at least about 1 wt % PET fibers, 1 wt % PET fibers, 2 wt % PET fibers, 3 wt % PET fibers, 4 wt % PET fibers, 5 wt % PET fibers, 6 wt % PET fibers, 7 wt % PET fibers, 8 wt % PET fibers, 9 wt % PET fibers, 10 wt % PET fibers, 11 wt % PET fibers, 12 wt % PET fibers, 13 wt % PET fibers, 14 wt % PET fibers, 15 wt % PET fibers, 16 wt % PET fibers, 17 wt % PET fibers, 18 wt % PET fibers, 19 wt % PET fibers, 20 wt % PET fibers, 21 wt % PET fibers, 22 wt % PET fibers, 23 wt % PET fibers, 24 wt % PET fibers, 25 wt % PET fibers, 26 wt % PET fibers, 27 wt % PET fibers, 28 wt % PET fibers, 29 wt % PET fibers, 30 wt % PET fibers, 31 wt % PET fibers, 32 wt % PET fibers, 33 wt % PET fibers, 34 wt % PET fibers, 35 wt % PET fibers, 36 wt % PET fibers, 37 wt % PET fibers, 38 wt % PET fibers, 39 wt % PET fibers, 40 wt % PET fibers, 41 wt % PET fibers, 42 wt % PET fibers, 43 wt % PET fibers, 44 wt % PET fibers, 45 wt % PET fibers, 46 wt % PET fibers, 47 wt % PET fibers, 48 wt % PET fibers, 49 wt % PET fibers, 50 wt % PET fibers, 51 wt % PET fibers, 52 wt % PET fibers, 53 wt % PET fibers, 54 wt % PET fibers, 55 wt % PET fibers, 56 wt % PET fibers, 57 wt % PET fibers, 58 wt % PET fibers, 59 wt % PET fibers, 60 wt % PET fibers, 61 wt % PET fibers, 62 wt % PET fibers, 63 wt % PET fibers, 64 wt % PET fibers, 65 wt % PET fibers, 66 wt % PET fibers, 67 wt % PET fibers, 68 wt % PET fibers, 69 wt % PET fibers, 70 wt % PET fibers, 71 wt % PET fibers, 72 wt % PET fibers, 73 wt % PET fibers, 74 wt % PET fibers, 75 wt % PET fibers, 76 wt % PET fibers, 77 wt % PET fibers, 78 wt % PET fibers, 79 wt % PET fibers, 80 wt % PET fibers, 81 wt % PET fibers, 82 wt % PET fibers, 83 wt % PET fibers, 84 wt % PET fibers, 85 wt % PET fibers, 86 wt % PET fibers, 87 wt % PET fibers, 88 wt % PET fibers, 89 wt % PET fibers, 90 wt % PET fibers, 91 wt % PET fibers, 92 wt % PET fibers, 93 wt % PET fibers, 94 wt % PET fibers, 95 wt % PET fibers, 96 wt % PET fibers, 97 wt % PET fibers, 98 wt % PET fibers, 99 wt % PET fibers, 100 wt % PET fibers, or any ranges and values disposed thereinbetween.

In some embodiments, the sound-absorbing cloth 122 demonstrates face deflection of less than 0.008 inches. In other embodiments, the sound-absorbing cloth 122 demonstrates face deflection of less than 0.005 inches. In yet other embodiments, the sound-absorbing cloth demonstrates face deflection of less than (<) about 0.010 inches (in), <0.009 in, <0.007 in, <0.006 in, <0.004 in, <0.003 in, <0.002 in, <0.001 in, or other ranges and values disposed thereinbetween.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and arrangement of the embodiments without departing from the scope of the present disclosure as expressed in the appended claims.

What is claimed is:

1. A pickleball paddle, comprising:
a striking surface; and
a sound-absorbing cloth disposed on the striking surface, wherein the sound-absorbing cloth comprises a fiber blend comprising at least about 10 weight % para-aramid fibers and at least about 1 weight % nylon fibers.

2. The pickleball paddle of claim 1, wherein the fiber blend further comprises at least 10 weight % nylon fibers.

3. The pickleball paddle of claim 1, wherein the sound-absorbing cloth further comprises a scrim disposed in the fiber blend.

4. The pickleball paddle of claim 1, wherein the sound-absorbing cloth further comprises a coating disposed on a surface of the sound-absorbing cloth.

5. The pickleball paddle of claim 4, wherein the coating comprises polyurethane.

6. The pickleball paddle of claim 1, wherein fibers disposed in the fiber blend are non-woven.

7. The pickleball paddle of claim 1, wherein the fiber blend has a weight of about 12 ounces per square yard (opsy) to about 18 opsy.

8. The pickleball paddle of claim 1, wherein the fiber blend further comprises at least about 10 weight % polyethylene terephthalate fibers.

9. A sound-absorbing cloth, comprising:
a fiber blend comprising:
at least about 30 weight % high-elongation polyester fibers; and
at least about 1 weight % nylon fibers.

10. The sound-absorbing cloth of claim 9, wherein the fiber blend further comprises at least about 10 weight % para-aramid fibers.

11. The sound-absorbing cloth of claim 9, further comprising a scrim disposed in the fiber blend.

12. The sound-absorbing cloth of claim 9, wherein fibers disposed in the fiber blend are non-woven.

13. The sound-absorbing cloth of claim 9, wherein the fiber blend has a weight of about 14 ounces per square yard (opsy) to about 16 opsy.

14. The sound-absorbing cloth of claim 9, further comprising an adhesive backing.

15. The sound-absorbing cloth of claim 14, wherein the adhesive backing is configured to attach to a striking surface of a pickleball paddle.

16. A method of assembling a pickleball paddle, the method comprising:
providing a pickleball paddle comprising a striking surface;
providing a sound-absorbing cloth comprising a fiber blend, the fiber blend comprising:
at least about 10 weight % para-aramid fibers or at least about 30 weight % high-elongation polyester fibers; and
at least about 20 weight % nylon fibers; and
fixing the sound-absorbing cloth to the striking surface.

17. The method of claim 16, wherein the sound-absorbing cloth is fixed to the striking surface by an adhesive backing.

18. The method of claim 16, wherein the sound-absorbing cloth is fixed to the striking surface by wrapping the sound-absorbing cloth around the pickleball paddle.

19. The method of claim 16, wherein the sound-absorbing cloth further comprises a scrim disposed in the fiber blend.

20. The pickleball paddle of claim 16, wherein the sound-absorbing cloth further comprises a coating disposed on a surface of the sound-absorbing cloth.
